(19) United States
(12) Patent Application Publication
(10) Pub. No.: US 2021/0005122 A1
(43) Pub. Date: Jan. 7, 2021

(54) Keyfob Activated Automobile Holographic

(71) Applicant: Armen Kirakosian, North Hollywood, CA (US)

(72) Inventor: Armen Kirakosian, North Hollywood, CA (US)

(21) Appl. No.: 16/459,246

(22) Filed: Jul. 1, 2019

(51) Int. Cl. G09G 3/00; G02B 27/22; G06F 3/02; B60R 11/02; G09F 21/04; G09F 19/18

(52) U.S. Cl. CPC G09G 3/001; G02B 27/2292; G06F 3/0202; B60R 11/0229; B60R 2011/004; G09F 19/18; G09G 2354/00; G09G 2370/16; G09G 2380/10; G09F 21/04

(57) ABSTRACT

A holographic system for an automobile includes a holographic pack configured to display a holographic image from atop an automobile, a wireless transceiver configured to transmit an image for holographic projection to the holographic pack, a software application configured to receive and to process an image from a user to the wireless transceiver based on processing signals from a key fob and multiple holographic projectors in the pack configured to display the holograph parallel to a length of the automobile and parallel to a front and a rear of the automobile.

### SUMMARY OF THE INVENTION

A holographic system for an automobile includes a holographic pack configured to display a holographic image from atop an automobile, a wireless transceiver configured to transmit an image for holographic projection to the holographic pack, a software application configured to receive and to process an image from a user to the wireless transceiver based on processing signals from a key fob and multiple holographic projectors in the pack configured to display the holograph parallel to a length of the automobile and parallel to a front and a rear of the automobile.

Also, a method is disclosed for displaying a holographic image from atop an automobile via a holographic pack. The method additionally includes transmitting an image for holographic projection to the holographic pack via a wireless transceiver. The method further includes receiving and processing an image from a user to the wireless transceiver based on processing signals from a key fob via a software application.

The disclosed holographic system further includes a memory of processed holographic images ready for display via the holographic pack. Signals processed from the key fob via the software application are generated by a user pressing a combination of OEM (original equipment manufacturer) buttons simultaneously. A magnetic backside of the holographic pack enables fixing it to a metallic topside of the automobile. The software application resides on a cell phone and or a dashboard component of the automobile like an onboard computer or microprocessor.

The disclosed holographic system further includes holographic projectors configured to display the holograph parallel to a length of the automobile and parallel to a front a rear of the automobile. The holographic pack is powered from a battery and from an inductive power coupling of the holographic pack to an inductive power coupler in the automobile. Multiple holographic packs project multiple advertising images atop the automobile.

Other aspects and advantages of embodiments of the disclosure will become apparent from the following detailed description, taken in conjunction with the accompanying drawings, illustrated by way of example of the principles of the disclosure.

### BRIEF DESCRIPTION OF THE DRAWINGS

FIG. 1 is a depiction of a key fob activated automobile holograph in accordance with an embodiment of the present disclosure.

FIG. 2 is a depiction of components of the key fob activated automobile holograph in accordance with an embodiment of the present disclosure.

FIG. 3 is a depiction of a method for advestising via a key fob activated automobile holograph in accordance with an embodiment of the present disclosure.

Throughout the description, same reference numbers may be used to identify same or similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Dimensions detailed herein and in the drawings are intended to be a guide to nominal manufacturing dimensions. The detailed dimensions may vary by plus or minus ten percent taking into account manufacturing restraints and materials for various embodiments as recited, taught and suggested herein. The dimensions therefore are applicable to at least one embodiment but are not meant to be limiting to other embodiments of the disclosure.

A hologram device is placed on top of an automobile so that when parked can advertise a company or any product or service desired. The concept entails utilizing a key fob activated holographic image (personal use locating image or business advertising image) on the top of the vehicle. (holographic technology currently exists, which can be adapted to automotive use and utilize pre-programmed images). A memory of stored images for holographic display are kept in the device or on the cloud accessible by the device.

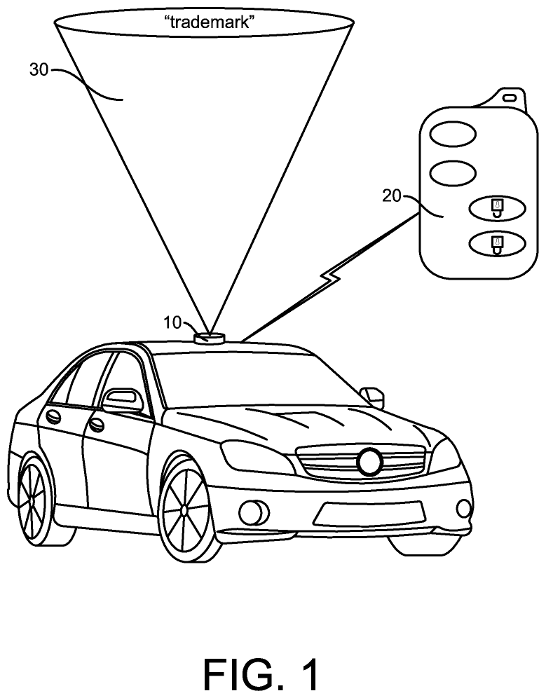

FIG. 1 is a depiction of a key fob activated automobile holograph in accordance with an embodiment of the present disclosure. The depiction includes a holographic pack 10, a key fob 20 and a holograph 30 displayed from atop a surface of a parked automobile.

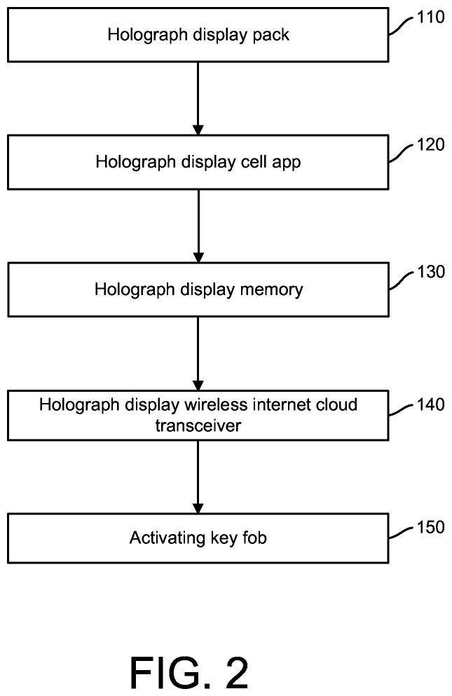

FIG. 2 is a depiction of components of the key fob activated automobile holograph in accordance with an embodiment of the present disclosure. The depicted components include a holographic pack 110, a holographic display software application 120, a holographic display memory 130, a holographic display wireless internet cloud transceiver 140 and an activating key fob 150.

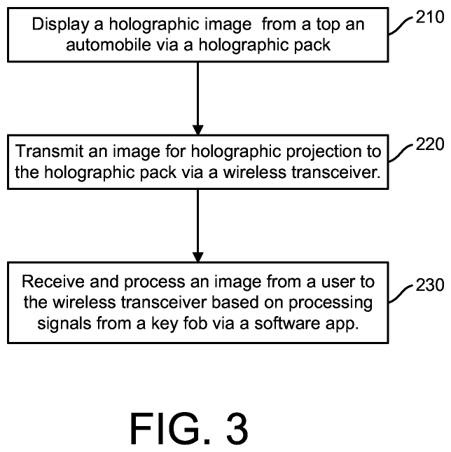

FIG. 3 is a depiction of a method for advertising via a key fob activated automobile holograph in accordance with an embodiment of the present disclosure. The method includes 210 displaying a holographic image from atop an automobile via a holographic pack. The method also includes transmitting 220 an image for holographic projection to the holographic pack via a wireless transceiver. The method additionally includes 230 receiving and processing an image from a user to the wireless transceiver based on processing signals from a key fob via a software application.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A holographic system for an automobile, comprising:
a holographic pack configured to display a holographic image from atop an automobile;
a wireless transceiver configured to transmit an image for holographic projection to the holographic pack;
a software application configured to receive and to process an image from a user to the wireless transceiver based on processing signals from a key fob; and
a holographic projector configured to display the holograph parallel to an outside length of the automobile.

2. The holographic system of claim 1, wherein the signals processed from the key fob are generated by a user pressing a combination of OEM (original equipment manufacturer) buttons simultaneously.

3. The holographic system of claim 1, further comprising a memory of processed holographic images ready for display via the holographic pack.

4. The holographic system of claim 1, further comprising a magnetic backside of the holographic pack configured to adhere to a metallic topside of the automobile.

5. The holographic system of claim 1, wherein the software application resides on a cell phone.

6. The holographic system of claim 1, wherein the software application resides on a dashboard component of the automobile.

7. (canceled)

8. The holographic system of claim 1, further comprising holographic projectors configured to display the holograph parallel to a front and a rear of the automobile.

9. The holographic system of claim 1, further comprising a battery power source inside the holographic pack.

10. A method for an automobile holograph, the method comprising:
displaying a holographic image from atop an automobile via a holographic pack;
transmitting an image for holographic projection to the holographic pack via a wireless internet transceiver;
receiving and processing an image from a user to the wireless transceiver based on processing signals from a key fob via a software application; and
displaying the holograph parallel to an outside length of the automobile via a holographic projector.

11. The method of claim 10, further comprising generating signals processed from the key fob by a user pressing a combination of OEM (original equipment manufacturer) buttons simultaneously.

12. The method of claim 10, further storing a plurality of processed holographic images ready for display via the holographic pack in an electronic memory.

13. The method of claim 10, further comprising fixing the holographic pack onto a metallic topside of the automobile via a magnetic backside of the holographic pack.

14. The method of claim 10, further comprising installing the software application onto a cell phone.

15. The method of claim 10, further comprising installing the software application onto a dashboard component of the automobile.

16. (canceled)

17. The method of claim 10, further comprising projecting the holograph parallel to a front and a rear of the automobile.

18. A holographic system for an automobile, comprising:
a holographic pack configured to display a holographic image from atop an automobile;
a wireless transceiver configured to transmit an image for holographic projection to the holographic pack;
a software application configured to receive and to process an image from a user to the wireless transceiver based on processing signals from a key fob;
a holographic projector configured to display the holograph parallel to an outside length of the automobile; and
a holographic projector configured to display the holograph parallel to a front and a rear of the automobile.

19. The holographic system for an automobile of claim 18, further comprising an inductive power coupling of the holographic pack from an inductive power coupler in the automobile.

20. The holographic system for an automobile of claim 18, further comprising a plurality of holographic packs configured to project multiple advertising images atop the automobile.
